(19) United States
(12) Patent Application Publication
(10) Pub. No.: US 2026/0196869 A1
(43) Pub. Date: Jul. 9, 2026

(54) COUNTER-BASED MULTI-LEVEL CONVERTER CONTROL

(71) Applicant: Infineon Technologies AG, Neubiberg (DE)

(72) Inventors: Sarim SIDDIQUE, Munich (DE); Dominik DICKSCHAT, Pasing (DE); Benno KÖPPL, Markt Indersdorf (DE)

(21) Appl. No.: 19/014,879

(22) Filed: Jan. 9, 2025

(51) Int. Cl. H02J 13/00; H02M 1/00

(52) U.S. Cl. CPC H02J 13/14; H02J 13/1321; H02M 1/0003; H02J 2105/30

(57) ABSTRACT

A power converter node is configured to receive an index value unique to the power converter node, and reset a counter associated with the index value responsive to a synchronization signal. The power converter node may receive a counter update signal that causes the power converter node to update the counter to control a state of the power converter node to supply energy to a load along with other power nodes of a multi-level converter.

### TECHNICAL FIELD OF THE INVENTION

This invention relates generally to power converters, and more specifically to techniques for controlling the nodes of a multi-level power converter.

### BACKGROUND

Multi-level power converters (MLC) are configured to drive a load by operating multiple converter nodes to supply a portion of an output voltage to the load. In some examples, the multiple converter nodes of an MLC may be controlled by sending isolated control messages to the nodes that causes the nodes to change state.

The isolated Universal Asynchronous Receiver-Transmitter (UART) protocol is one example of a relatively low-cost/low-power communications protocol that is commonly used in automotive applications. Such a low-cost/low-power communications protocol may be unsuitable for some MLC applications which require the control of a relatively large number of nodes and/or operates at a relatively fast speeds.

### SUMMARY

In some aspects, a power converter node is configured to receive an index value unique to the power converter node. The power converter node is further configured to reset a counter associated with the index value responsive to a synchronization signal. The power converter node is further configured to receive a counter update signal that causes the power converter node to update the counter to control a state of the power converter node to supply energy to a load along with other power nodes of a multi-level converter.

In some aspects, a main controller is configured to send a unique index value to multiple power converter nodes. The main controller is further configured to send a synchronization signal that causes the multiple power converter nodes to reset a counter associated with the index value. The main controller is further configured to send a counter update signal to the multiple power converter nodes that causes the multiple power converter nodes to update the counter to control a state of the multiple power converter nodes to supply energy to a load.

In some aspects, a method includes receiving an index value unique to a power converter node. The method further includes resetting a counter associated with the index value responsive to a synchronization signal. The method further includes receiving a counter update signal that causes the power converter node to update the counter to control a state of the power converter node to supply energy to a load along with other power nodes of a multi-level converter.

### BRIEF DESCRIPTION OF THE DRAWINGS

FIG. 1 is a block diagram that depicts one example of a multi-level converter (MLC) system according to some embodiments.

FIG. 2 is a block diagram depicting one example of a power converter node according to some embodiments.

FIG. 3 is a plot that depicts one example of a sinusoidal output voltage that may be generated by an MLC system according to some embodiments.

FIG. 4 is a block diagram that depicts one example of a counter update signal according to some embodiments.

FIG. 5A is a plot showing one example of a counter update signal being used to control nodes of an MLC system to generate a sinusoidal output voltage according to some embodiments.

FIG. 5B is a plot showing one example of a counter update signal being used to control nodes of an MLC system to generate a sinusoidal output voltage.

FIG. 5C is a plot showing one example of a counter update signal being used to control nodes of an MLC system to generate a sinusoidal output voltage according to some embodiments.

FIG. 6 is a flow diagram that depicts one example of a method of operating a node of an MLC system according to some embodiments.

### DETAILED DESCRIPTION

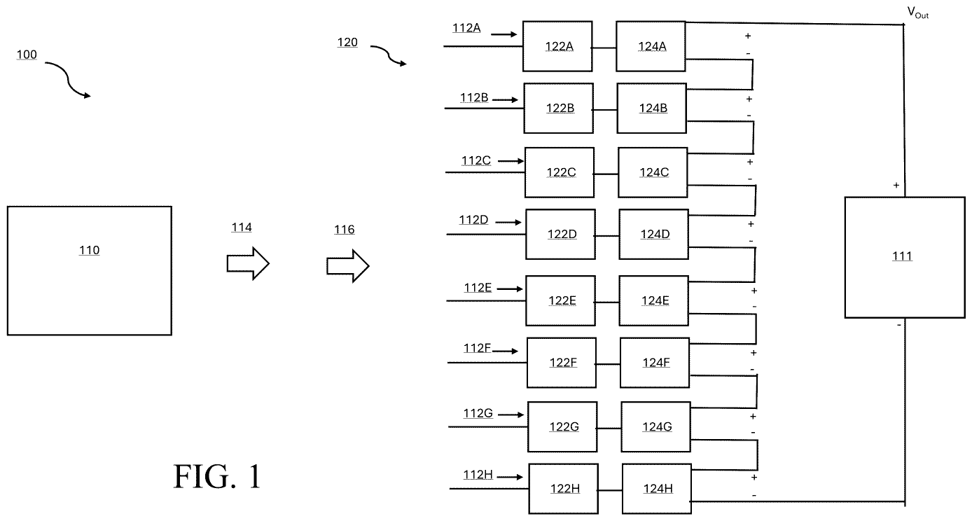

FIG. 1 is a block diagram that depicts one example of a multi-level converter (MLC) system 100 according to some embodiments. In the example of FIG. 1, system 100 includes a main controller 110 communicatively coupled to multiple power converter nodes 120 configured to collectively supply energy to one or more load(s) 111. As depicted, each of the nodes 120 includes a node controller 122A-122H coupled to control a bridge circuit 124A-124H to couple energy from a power source (not shown) to the load(s) 111. Although not depicted in FIG. 1, each bridge circuit 124A-124H includes at least one power switch such as a power MOSFET or similar device that is controllable to couple a power source to the load(s) 111. For example, each bridge circuit 124A-124H may include a cascaded H-bridge circuit with at least a high side and a low side power switch configured to be turned on or turned off to control a power supply state of the node. In some examples, each bridge circuit 124A-124H is configured to couple or decouple (bypass) energy from to an integrated power source, such as a battery or cell of a battery pack to the load(s) 111.

The node controllers 122A-122H may control a state of the respective bridge circuit 124A-124H in one of a few defined states. For example, the node controllers 122A-122H may control the respective bridge circuits 124A-124 to: supply energy of a first polarity to the load(s) 111 (i.e., a voltage greater than zero volts), supply energy of a second polarity to the load(s) 111 (i.e., with a voltage less than zero volts), or bypass the respective energy source so that the respective bridge circuit 124A-124H does not supply energy to the load(s) 111.

In some examples, the main controller 110 is coupled with the converter nodes 120 to control the converter nodes 120 to collectively supply energy to approximate an alternating current (AC) signal by generating an output voltage that varies sinusoidally. For example, the load(s) 111 may be one or more phases of a three-phase motor (not shown) configured to be driven by sinusoidal output voltage. As another example, the load(s) 111 may be an energy grid, and system 100 is configured to convert energy from a direct current (DC) source such as cells of a battery to supply the energy grid. In still other examples, the load(s) 111 may include one or more AC or DC electrical outlets or plugs. In some examples, the sinusoidal output voltage may be rectified by a rectifier and/or other circuitry used to provide an auxiliary voltage bus for a vehicle. In still another example, a rectified sinusoidal output voltage may be used to provide a high voltage 12V DCDC power bus.

As described above, each of the nodes 120 may be coupled to a direct current energy source such as a battery pack and/or one or more cells of a battery pack. Depending on the application, system 100 may include any number of nodes 120 configured to each supply a portion of an output voltage to the load(s) 111. As one non-limiting example where the load(s) 111 is a phase of motor configured to operate based on an alternating current signal that ranges from- 360 volts to 360 volts may include twelve nodes each coupled to a battery pack configured to output 0, 30, or −30 volts such that when each of the twelve nodes is operated to couple energy to the load(s) 111, the nodes collectively supply 360 volts. As another example, system 100 may include 24 nodes each configured to output 0, 30, or −30 volts to collectively output a voltage with a range of −720 to 720 volts. As still another example, system 100 may include 24 nodes each configured to output 0, 15, or −15 volts to collectively output −360 to 360 volts. System 100 may include any number of nodes 120 configured to be operated to collectively supply energy at any number of volts. For example, system 100 may include anywhere from two nodes to 24, 36, 48, or even more nodes configured to collectively supply energy to the load(s) 111 at any range of voltages, including at 240, 360, 720, or any other number of volts.

In the FIG. 1 example, the main controller 110 is coupled to communicate with the nodes 120 to control a state of the nodes 120 to deliver energy to the load(s) 111. For example, the main controller 110 may be coupled to the respective nodes through a ring topology, a star topology, a bus topology, a daisy chain topology, a daisy chain in loop topology, or any other type of suitable topology. In some examples, system 100 may utilize a relatively low cost and/or low power means to communicate with the respective nodes 120. As one non-limiting example, system may use a universal asynchronous serial transmitter (UART) protocol to perform isolated communicate with the node(s) 120. In some examples, system 100 may be coupled to communicate by sharing a single communications channel (e.g., implemented by a single conductor) between the main controller 110 and multiple nodes 120, as shown in the FIG. 1 example. In other examples not shown, system 100 may use other types of electrically isolated communication protocols using single wire, differential wire, or other coupling between the main controller 110 and the nodes 120.

According to traditional multi-level converter systems, a main controller 110 may send traditional isolated UART messages that each include multiple bytes of data to actuate the nodes to change state. In some examples, it may take 24 microseconds or longer for a traditional isolated UART message from a main controller to be sent to and executed by a power converter node. In some examples, traditional UART communications may be unsuitable for some applications, for example where the system includes many power converter nodes and/or operates with a switching pattern at relatively high frequencies. In traditional systems, relatively high cost and/or high-power consumption communications protocols such as ethernet, EtherCAN, RS485, or the like may be used to implement more complex and/or faster MLC systems.

System 100 depicted in FIG. 1 is uniquely configured to enable multi-level conversion to be implemented at relatively fast speeds using a low power and/or low cost communications protocol such as UART to control the nodes 120. According to these examples, the nodes 120 are configured to implement counters, and the main controller 110 is configured update the counter to control the nodes 120. In this matter, shorter messages containing fewer bit of data are used for communication to control the nodes 120, which may enable system 100 to operate at faster speeds than traditional systems.

According to the FIG. 1 example, the main controller 110 sends a unique index value 112A-112H to multiple nodes 120 of the system 100. In some examples, the unique index values 112A-112H may be sent by the main controller 110 to the respective nodes 120 via a traditional UART message addressed to each node.

In some examples, the system 100 may include a number of N nodes 120, and the main controller 110 sends a unique index value 112A-112H to each of the N nodes of the system 100 as shown in FIG. 1. In other examples, the main controller 110 sends a unique index value 112A-112H to less than the total number of N nodes of the system 100 that are to be controlled during a switching operation of the system 100. In some examples, the main controller 110 sends a unique index value 112A-112H to all or some of the N nodes of the system 100, and sends a further identifier signal that indicates that a power converter node is one of less than all of the N nodes of the system 100 that are to operate responsive to a counter update signal to supply energy to the load(s) 111.

The unique index value 112A-112H is assigned by the main controller 110 to the respective nodes to define an order in which the nodes 120 are to be actuated to change state relative to other nodes in a switching operation of system 100, for example to provide all or part of a sinusoidal output voltage to the load(s) 111. In some examples, the main controller 110 may assign the unique index value 112A-112H with an order defined to balance actuation of the battery cells associated with each node 120. In some examples, the main controller 110 may change the order between switching operations of system 100 by changing the unique index values 112A-112H associated with each node 120 during operation of system 100 to supply energy to the load(s) 111. In some examples, the main controller 110 may resend unique index values 112A-112H to the nodes 120 at regular intervals during operation of system 100 for cell balancing purposes.

In some examples, the main controller 110 may send the unique index values 112A-122H to the respective nodes 120 during a startup operation of system 100. In other examples, the main controller 110 may send the unique index value 112A-112H at a time when system 100 is operated to communicate less frequently, such as at a maximum or minimum voltage level of the sinusoidal output voltage of system 100. As one non-limiting example, the main controller 110 may send the unique index value 112A-112H as traditional UART messages during a time when all active nodes are collectively operated in bypass or are collectively operated to supply a positive or negative output voltage to the load(s) 111.

As mentioned above, the unique index value 112A-112H may correspond to a value or values of a counter (not shown in FIG. 1) associated with each of the nodes 120. For examples, the unique index value 112A-112H may correspond to an order in which each respective node of system 100 is to be operated to change state relative to a value of the counter.

In some examples, the unique index value 112A-112H may be specific to a particular node of system 100 and unique to that node. In other examples, the unique index value 112A-112H may correspond to a grouping of nodes configured to be controlled to change state together based on the value of the counters. According to such examples, the respective nodes 120 may be arranged in pairs, triplets, or other grouping, and configured to change state responsive to the same value of the counters.

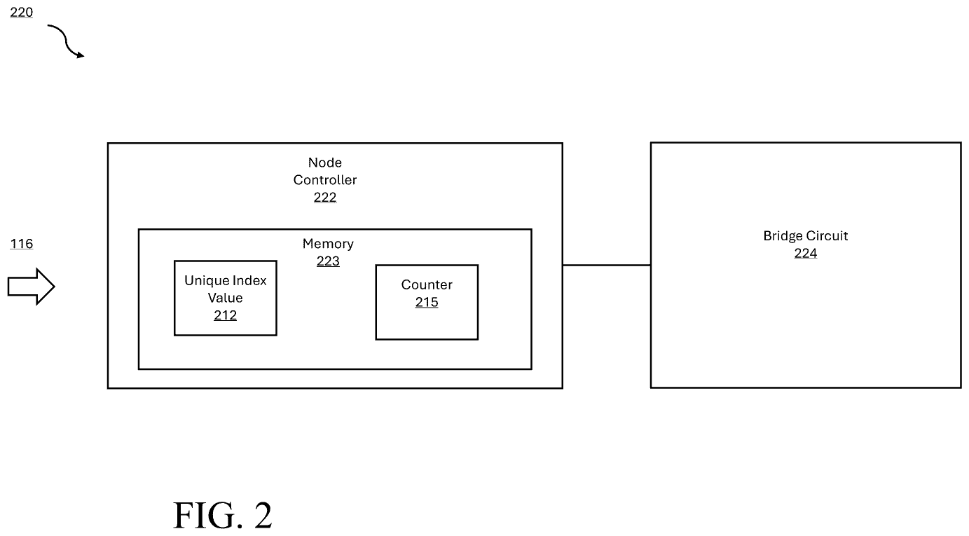

FIG. 2 is a block diagram depicting one example of a power converter node 220, which may be used as any of the converter nodes 120 depicted in FIG. 1 according to some embodiments. The node 220 includes a node controller 222 configured to control a state of a bridge circuit 224 to supply energy to one or more load(s) 111. The bridge circuit 224 may be a cascaded H-bridge circuit or another type of bridge circuit. As shown in FIG. 2, the node controller 222 includes a memory 223 which is configured to store a unique index value 212 and a counter 215. As described above, the node controller 222 may store the unique index value 212 in memory 223 after being received from the main controller 110 as a message.

As shown in FIG. 2, the node controller 222 may also store a counter 215 in the memory 223. The counter 215 may be used by the node controller 222 to control a state of the bridge circuit 224.

The node controller 222 may reset the counter 215 to a value C=0 responsive to receipt of a synchronization signal 114 from the main controller 110 as shown in FIG. 1. The node controller 222 may receive the synchronization signal 114 corresponding to a zero crossing of the system 100, when all the nodes 120 are operated in bypass and do not couple energy to the load(s) 111, i.e., an output voltage of system 100 equals zero or substantially zero. The zero crossing may correspond to timing of a switching operation of the system 100, or responsive to a change in a condition of the load(s) 111 (e.g., a load jump, the output voltage being pulled to zero, etc.).

After the synchronization signal 114 has been received and the counter 215 reset in response, the node controller 222 may then update a value of the counter 215 responsive to a counter change signal 116 from the main controller 110 that indicates whether the counter 215 should be incremented or decremented.

The node controller 222 may change a state of the bridge circuit 224 based on comparing the value of the counter 215 to the unique index value 212. If the value of the counter 215 corresponds to the unique index value 212 of the node 220, the node controller 222 may change a state of the node 220 by controlling the bridge circuit 224 to change state. In contrast, if the value of the counter 215 does not correspond to the unique index value 212 of the node (i.e., the counter 215 is not equal to the index value 212), the node controller 222 may maintain a state of the node 220 by controlling the bridge circuit 224 to not change state.

As a non-limiting example, the node controller 222 may be part of a system 100 that includes eight nodes as shown in FIG. 1, each of which received a unique index value between N1 and N8 and are configured to control the bridge circuit 224 to change state when a value of the counter 215 equals the respective unique index value 212. As one specific and non-limiting example, if node 220 received a unique index value of N3, node controller 222 may be configured to change a state of the bridge circuit 224 responsive to a value of the counter 215 changing to or from the counter value C=3. Similarly, a further node that received a unique index value of N4 may be configured to change a state of the bridge circuit responsive to a value of the counter 215 changing to or from the counter value C=4.

Referring back to FIG. 1, once the unique index value 212 is sent and stored in memory 223 by the respective node controller 222, the main controller 110 controls the nodes 120 to deliver energy to the load(s) 111 by updating the counters 215 associated with each node. For example, the main controller 110 may repeatedly send a counter update signal 116 as a broadcast message to the nodes 120 of system 100 that indicates the nodes should increment, decrement, or reset the respective counters 215 to zero.

Referring back to FIG. 2, the node controller 222 may be configured to change a state of the bridge circuit 224 when the value of the counter 215 corresponds to the unique index value 212 stored in the memory 223 associated with each node. For example, the node controller 222 may change a state of the bridge circuit 224 when the counter 215 equals the unique index value 212 for the particular node. In some examples, the node controller 222 may maintain a state of the bridge circuit 224 when the counter does not equal the unique index value.

In some examples, the node controller 222 may change a state of the bridge circuit 224 when the value of the counter 215 is greater than or less than the unique index value 212 associated with the node. For example, if a counter update signal 116 indicates that the counter 215 should be incremented and a previous counter update signal 116 was missed due to a transmission error, the node controller 222 may change the state of the bridge circuit 224 when the value of the counter 215 is greater than the unique index value 212 for the node. As another example, if a counter update signal 116 indicates that the counter 215 should be decremented and a previous counter update signal 116 was missed due to a transmission error, the node controller 222 may change the state of the bridge circuit 224 when the value of the counter 215 is less than the unique index value 212 for the node.

As described above, the main controller 110 may use the counter update signal 116 to sequentially change the state of the respective nodes 120 of system 100, one after another, to generate a desired output waveform, such as a digital approximation of sinusoidal output voltage. In some examples, by using the counter update signal 116, main controller 110 may control the nodes 120 using shorter messages (e.g., with fewer bits of data) that may be communicated faster than traditional MLC control techniques.

In some examples, using the counter update signal 116 may enable system 100 to be used to support MLC systems with a greater number of nodes and/or that are operated at higher switching frequencies in comparison to traditional systems. For example, where system 100 is configured to operate using an isolated UART protocol as described above, the main controller 110 may control the nodes 120 to change state within less than 10 microseconds, and in some examples within 6.63 microseconds.

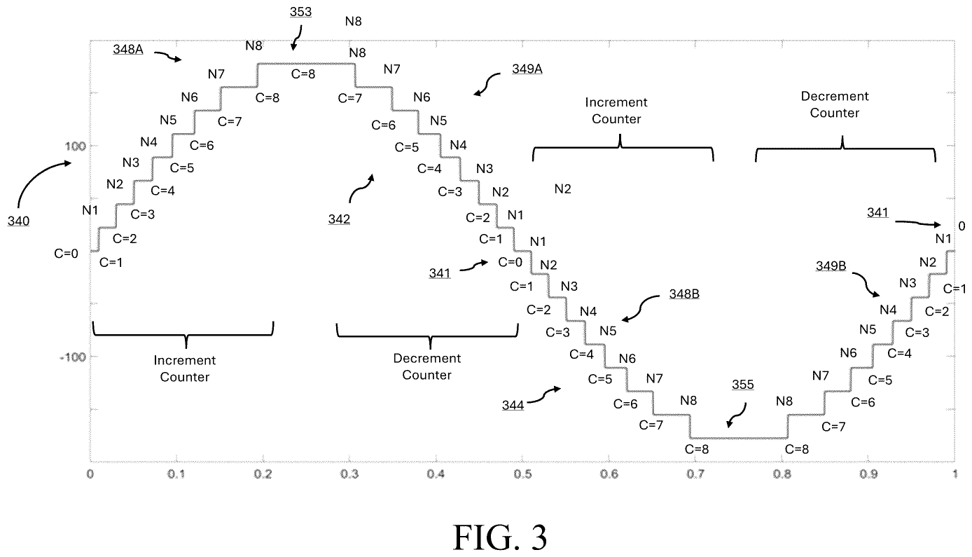

FIG. 3 is a plot that depicts one example of a sinusoidal output voltage 340 that may be generated by an MLC system according to some embodiments. The converter system 100 may generate the sinusoidal output voltage 340 to supply AC energy to a load, such as a phase of an alternating current motor. In some examples, the load(s) 111 may be a phase of an electric vehicle drivetrain motor, an electrical power grid, an outlet, a plug, an AC or DC power bus, an auxiliary power bus, or any other type of load or load(s) configured to be driving by the sinusoidal output voltage 340 shown in FIG. 3.

In the example of FIG. 3, the sinusoidal output voltage 340 is generated by using a counter update signal 116 to sequentially change a state of eight unique identifiers N1-N8 associated with multiple power nodes. As described above with respect to FIG. 1, the unique identifiers N1-N8 have been sent to eight nodes of system 100 depicted in FIG. 1. In other examples not depicted, system 100 may include more or fewer than 8 nodes, for example system 100 may include 2, 4, 8, 16, 32, 64, 128, or even more nodes. In still other examples not depicted, the unique identifiers N1-N8 depicted in FIG. 3 may be associated with a grouping of nodes configured to change state together. According to one such non-limiting example, the unique identifiers N1-N8 may each be associated with a pair, triplet, or other grouping of nodes configured to change state when a value of the counters 215 corresponds to the same unique identifier (i.e., N1). Hereinafter, the phrase “node(s) N1-N8” refer to a single node associated with each unique identifier N1-N8 or multiple nodes associated with each unique identifier N1-N8.

As shown in the example of FIG. 3, the main controller 110 is configured to send the counter update signal 116 to generate a sinusoidal output voltage 340 that includes a positive part 342 with an increasing part 348A that increases from zero to a maximum output voltage 353, and a decreasing part 349A that decreases from the maximum output voltage 353 to a zero crossing 341 where the output voltage is substantially zero volts. As shown in FIG. 3, the sinusoidal output voltage 340 also includes a negative part 344 with an increasing part 348B that increases from zero to a minimum output voltage 355, and a decreasing part 349B that decreases from the minimum output voltage 355 to zero.

As shown in the FIG. 3 example, the main controller 110 is configured to send the counter update signal 116 to update the respective counters of the node(s) N1-N8, which causes the respective node(s) N1-N8 to change state in sequence to supply energy to the load(s) 111 based on the value of the counters 215. In the example of FIG. 2, an order of each of the node(s) N1-N8 as defined by the unique index value 212 is shown. As depicted, each of the respective node(s) N1-N8 is configured to change state based on comparing a value C of the respective counter 215 to the unique index value 212 associated with each of the respective node(s) N1-N8.

In some examples, the respective node(s) N1-N8 may be configured to change state when the unique index value 212 for a particular node is equal to the value C of the counter 215. In some examples, the respective node(s) N1-N8 may also be configured to change state when the unique index value 212 is greater than or less than the value C of the counter 215, for example due to a transmission error. As an example, if counter 215 associated with a node is being incremented and a previous counter update signal is missed due to a transmission error, the node may change state when the unique index value 212 is greater than the value C of the counter 215. As another example, if counter 215 associated with a node is being decremented and a previous counter update signal is missed due to a transmission error, the node may change state when the unique index value 212 is less than the value C of the counter 215.

At the leftmost side of FIG. 3, system 100 is operated to generate an increasing part 348A of the positive part 342 of the sinusoidal output voltage 340. As shown, the counter(s) C initially have a value of zero, after the counter(s) C have been reset, for example responsive to a synchronization signal 114 received from the main controller 110. With the counter value C=0, the node(s) N1-N8 are operated in a bypass state such little or no energy (e.g., zero volts) is supplied to the load(s) 111. As shown in FIG. 3, during the increasing part 348A, the counter update signal 116 is configured to increment the counter C. As shown in FIG. 2, after a first counter update signal 116 is received by the node(s) N1-N8, each of the node(s) N1-N8 increments their respective counter 215 to the value C=1. A node in the first position N1 in the order defined by the unique index value 212 changes state to from bypass to supply energy to the load(s) 111, as shown by the first step in the sinusoidal output voltage 340. The other node(s) N2-N8 in the order with a unique index value 212 greater than the counter value C=1 do not change state responsive to the counter value being updated, and remain in a bypass state to supply substantially zero volts to the load(s) 111.

Referring again to FIG. 3, the main controller 110 sends a further counter update signal 116 configured to update the counter(s) 215, and the node(s) N1-N8 increment their respective counters 215 to the value C=2. Responsive to the counter 215 incrementing to the value of C2, the node(s) N2 in second position in the order transitions from the bypass state to supplying a positive voltage to the load(s) 111, as shown by the second step in the sinusoidal output voltage 340. As shown, the node(s) N1 remains in the state supplying a positive voltage to the load(s) 111. As shown in FIG. 2, the main controller 110 sends further counter update signals 116 that cause the counters 215 of the node(s) N1-N8 to be updated to the value C=3, then C=4, then C=5, and so on up to the value of C=8, and the nodes N3-N8 are each accordingly transitioned from the bypass state to supplying a positive voltage to the load(s) 111 responsive to the counter value being equal to (or greater than if a transmission error causes a counter update signal to be missed) the unique identifier associated with each of the node(s) N1-N8. As shown in FIG. 3, at a maximum output voltage 353, all eight node(s) N1-N8 are operated to supply a positive voltage to the load(s) 111.

As shown in FIG. 3, after the increasing part 348A, the main controller 110 sends further counter update signals 116 to generate the decreasing part 349A of the sinusoidal output voltage 340. As shown, during the maximum voltage 353, the counter(s) C have a value of C=8. To generate the decreasing part 349A, the main controller 110 sends a counter update signal 116 to the node(s) N1-N8 to decrement the counters 215. Each of the respective node(s) N1-N8 is configured to change state (transition to the bypass mode from supplying a positive voltage) responsive to the counter value being decremented. As shown in FIG. 2, after such a counter update signal 116, the node(s) N1-N8 decrement their respective counters to a value of C=7. As shown, responsive to the counter value of C=7, the node(s) N8 in last position in the order transitions to the bypass state to stop supplying a positive voltage to the load(s) 111, while the nodes N1-N7 do not change state. The main controller 110 sends a further counter update signal 116 to decrement the counters 215, and the node(s) N1-N8 120 decrement their respective counters to the value C=6. Responsive to the counters 215 decrementing to the value of C=6, the node N7 in the second to last position in the order transitions to the bypass state to cease supplying a positive voltage to the load(s) 111, while the nodes N8 and N1-N6 do not change state. As shown in FIG. 3, the main controller 110 sends further counter update signals 116 that indicate the respective counters 215 should be decremented to a value of C=6, then C=5, then C=4, and so on down to the value of C=1, and the nodes N6-N1 are each accordingly transitioned from supplying a positive voltage to the load(s) 111 to the bypass state to responsive to the counter 215 value being equal to (or less than if a transmission error causes a counter update signal to be missed) the unique identifier associated with each of the nodes N6-N1, until each of the nodes N6-N1 transitioned to the bypass state. As shown in FIG. 2, at zero crossing 341 of the sinusoidal output voltage 340, all eight node(s) N1-N8 are transitioned to the bypass mode such that substantially zero volts are supplied to the load(s) 111.

In some examples, system 100 may be configured to supply energy to the load(s) 111 that configured to be driven by a rectified sinusoidal waveform, meaning by a voltage that remains positive throughout a switching cycle. According to such examples (not shown), the main controller 110 may, after controlling the nodes 120 to generate the positive part 342 of sinusoidal output voltage 340, reset the counter to C=0, and resend the counter update signals 116 as described above to generate another positive part 342 of the waveform.

In other examples, such as where the load(s) 111 are configured to be driven by an unrectified sinusoidal output voltage as shown in FIG. 3, the main controller 110 may control the node(s) N1-N8 to generate the negative part 344 of the sinusoidal output voltage 340. According to these examples, the main controller 110 may repeatedly output counter update signals 116 to increment and/or decrement the counters 215 to sequentially transition the node(s) N1-N8 from the bypass state to couple energy of a negative polarity to the load(s) 111. For example, the main controller 110 may output the counter update signals 116 to increment the counters from C=0 to C=8 such that the node(s) N1-N8 sequentially transition from supplying zero volts at zero crossing 241 to a minimum voltage 355 when each of the node(s) N 1-N8 is operated to couple a negative voltage to the load(s) 111, as shown on the right side of the FIG. 3 plot. As another example, the main controller 110 may output the counter update signals 116 to decrement the counters 215 from C=8 to C=0 such that the node(s) N1-N8 are sequentially transitioned from supplying a minimum voltage 355 to supplying zero volts to the load(s) 111 when each of the node(s) N1-N8 is in a bypass state.

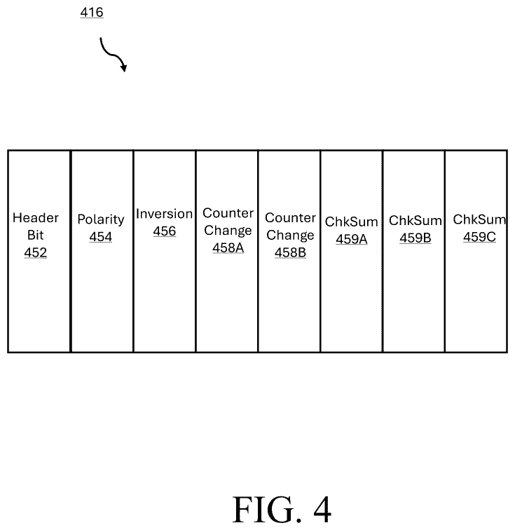

FIG. 4 is a block diagram that depicts one example of a counter update signal 416 according to some embodiments. The counter update signal 416 may be sent by a main controller 110 to multiple power converter nodes 120 of a multi-level converter system 100 to control the nodes 120 to deliver energy to one or more load(s) 111. As described above, the multiple nodes 120 may have each been assigned a unique index value 212 that specifies an order of the respective node(s) relative the value of a counter 215. For example, when a value of the counter 215 equals the unique index value 212 associated with a node, the node may change from supplying energy to the load to a bypass state, or vice versa.

As shown in FIG. 4, the counter update signal 416 includes a header bit 452 and a pair of counter change bits 458A, 458B. The header bit 452 may include a single binary bit with a dominant value (i.e., logic 1 if a logic 1 overrides a logic zero) that serves to announce to a receiving node that contents of a message are being transmitted. The pair of counter change bits 458A, 458B are used to signal to the nodes whether to increment, decrement, or reset the counters 215 to zero. For example, a value of 01 for the counter change bits 458A, 458B may indicate that the nodes 120 are to increment the counters 215. As another example, a value of 10 for the counter change bits 458A, 458B may indicate that the nodes 120 are to decrement the counters 215. As another example, a value of 00 for the counter change bits 458A, 458B may indicate that the nodes 120 are to reset the counters 215 to a value of zero. In some examples, the counter update signal 416 with a value of 00 for the counter change bits 458A, 458B is sent as a synchronization signal 114 configured to reset the counters 215 to zero.

In some examples, the respective nodes 120 of system 100 are configured to change state (transition from bypass to supplying a positive or negative voltage, or vice versa) when a value of the counter 215 equals the unique index value 212 that the respective node previously received and stored in memory. As a non-limiting example, a node with a unique index value of N3 may transition from a bypass state to supplying energy, or vice versa, responsive to the counter 215 being updated to the value C=3.

In some examples, the respective nodes 120 of system 100 may also be configured to transition an energy delivery state if the counter value is greater than the unique index value 212 associated with the particular node. For example, if a transmission failure causes a counter update signal 116 configured to increment or decrement the counter to a value of C=3 to be missed by a node with a unique identifier N3 due to a transmission error, the node N3 may also change state responsive to a counter value greater than C=3. According to such examples, the node N3 may transition responsive to the counter 215 updating to the value of C=4, C=5, C=6, C=7, and/or C=8 if the node N3 has not yet changed state responsive to the counter value C=3.

As shown in FIG. 4, the counter update signal 416 further includes a polarity bit 454 and an inversion bit 456, which may be used by the main controller 110 to operate the nodes 120 differently to generate respective parts of the sinusoidal output voltage 340 as shown in the FIG. 3 example. In some examples, the polarity bit 454 may be asserted to control the nodes 120 differently to generate the positive part 342 and the negative part 344 of the sinusoidal output voltage 340. For example, if the counter update signal 416 includes a polarity bit 454 of a first value (e.g., logic 0), the nodes 120 may be configured to transition between the bypass state and coupling energy of a positive polarity to the load(s) 111 to supply the positive part 342 of the output voltage 340. As another example, if the counter update signal 416 includes a polarity bit of a second value (e.g., logic 1), the nodes 120 may be configured to transition between the bypass state and coupling energy of a negative polarity to the load(s) 111 to supply the negative part 344 of the output voltage 340 to the load(s) 111.

In some examples, the inversion bit 456 may be asserted to control the nodes 120 differently to generate different parts of the sinusoidal output voltage 340. For example, if the counter update signal 416 includes an inversion bit 456 of a first value (e.g., logic 0), the nodes 120 may be configured to transition responsive to the counter value according to the order defined by the unique index values sent to each node. In some examples, if the counter update signal 416 includes an inversion bit 456 of a second value (e.g., logic 1), the nodes 120 may be configured to transition responsive to the counter value according to an inverse of the order defined by the unique index values sent to each node. For example, with the inversion bit 456 asserted, a node N1 in a first position in the order defined by the unique identifier may be configured to transition last, a node N2 in a second position in the order may be configured to transition second to last, a node N3 in a third position in the order may be configured to transition third to last, and so on such that the order defined by the unique index value 212 is inverted.

In some examples, the main controller 110 may apply the inversion bit 456 differently between the positive part 342 and the negative part 344 of the sinusoidal output voltage 340. In other examples, the main controller 110 may apply the inversion bit 456 differently between an increasing part 348A, 348B of the sinusoidal output voltage 340 and a decreasing part 349A, 349B of the sinusoidal output voltage 340.

As shown in FIG. 4, the counter update signal 416 may in some examples include one or more checksum bits 459A, 459B, and 459C that follow the counter change bits 458A, 458B, polarity bits 454, and/or inversion bits 456 in the counter update signal 416. The checksum bits 459A-459C may be used by the main controller 110 and/or nodes 120 to verify that the counter update signal 416 was successfully transmitted. For example, the main controller 110 and./or nodes 120 may compare checksum bits 459A, 459B, and 459C of a received message to the checksum bits 459A, 459B, and 459C sent with the counter update signal 416 to identify any transmission errors associated with communication of the counter update signal 416.

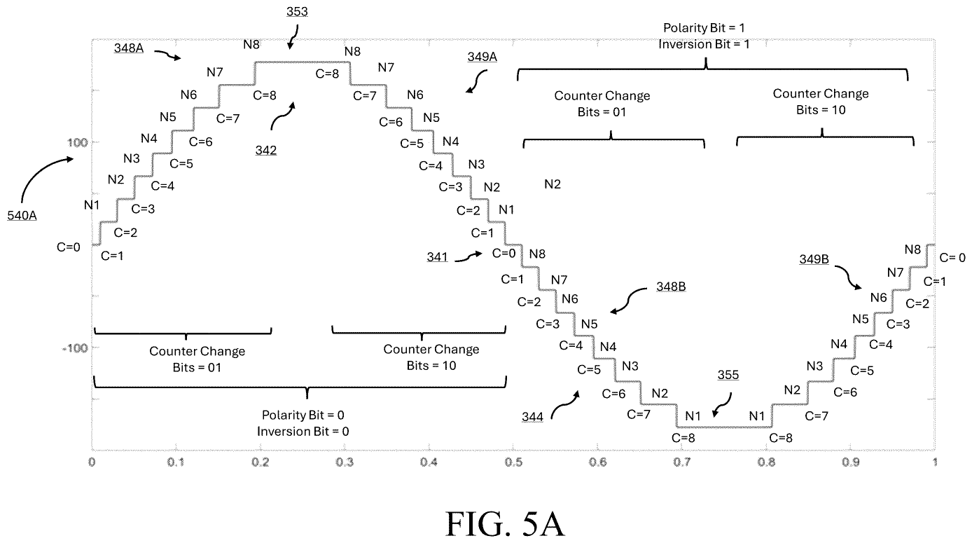

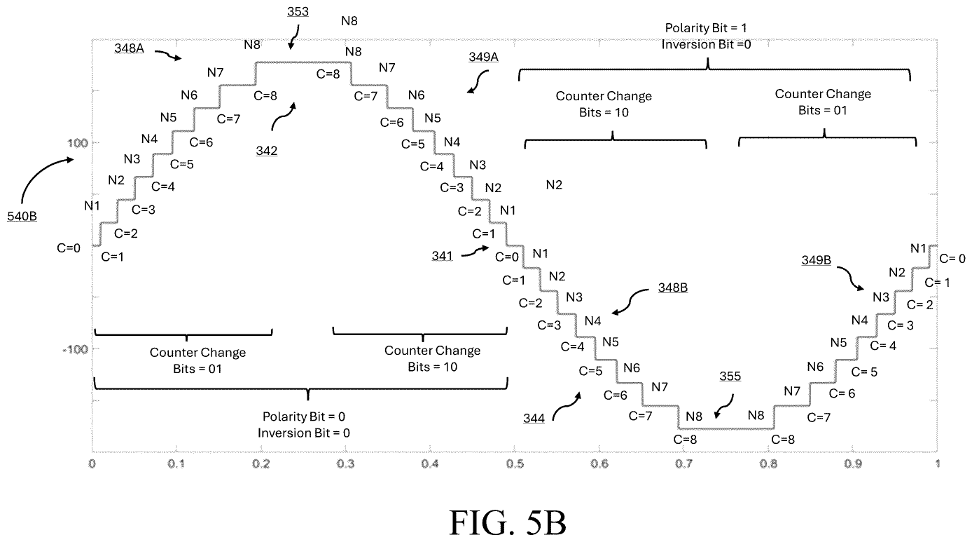

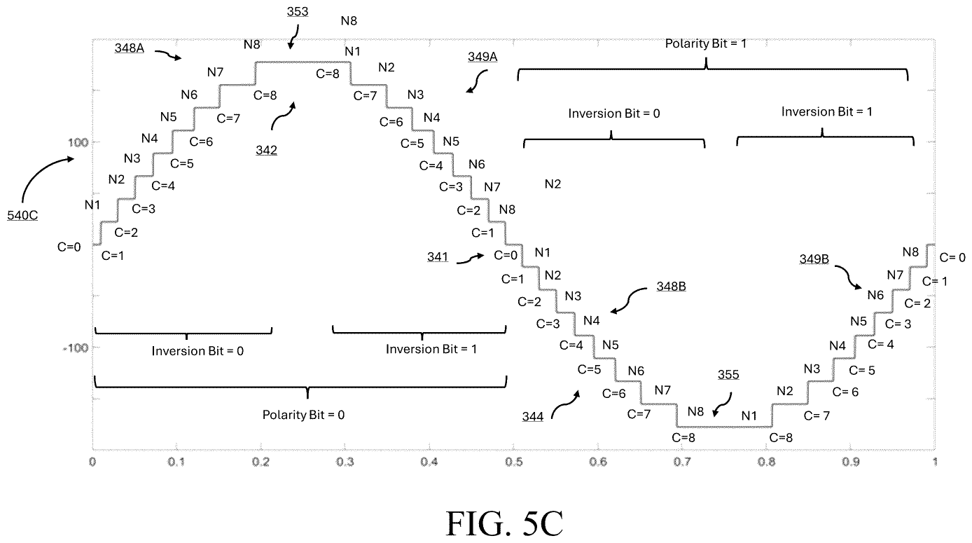

FIG. 5A is a plot showing one example of a counter update signal 416 being used to control nodes of a multi-level converter system 100 to generate a sinusoidal output voltage 540A according to some embodiments. The example of FIG. 5A is substantially similar to the example of FIG. 2 and shows plurality of nodes 120 of system 100 which have been assigned a unique index value N1-N8 that indicates an order of the nodes relative to a counter local to each node. FIG. 5A shows the value of respective counter change bits 458A, 458B, polarity bit 454, and inversion bit 456 used to generate the respective parts of the sinusoidal output voltage 540A.

As shown in FIG. 5A, to implement the increasing part 348A of the positive part 342 of the output voltage 540A, the counter change bits 458A, 458B are set to a value of 01, indicating that the counters 215 should be incremented responsive the counter update signals 116. As also shown, to implement the increasing part 348A of the positive part 342 of the output voltage 340, the polarity bit 454 is not asserted (e.g., logic (0)), indicating that the nodes 120 are to transition between a bypass state in which no energy is coupled to the load(s) 111 and coupling a positive output voltage to the load(s) 111. As also shown, to implement the increasing part 348A of the positive part 342 of the output voltage 340, the inversion bit 456 has a value of zero, indicating that each respective node should transitioned to coupled energy to the load(s) 111 based on an order defined by the unique index value of each node, not the inverse of that order. As shown in FIG. 5A, the counter update signals 416 are sent as described to generate the increasing part 348A of the positive part 342 of the output voltage 340.

As also shown in FIG. 5A, to implement the decreasing part 349A of the positive part 342 of the output voltage 540A, the counter change bits 458A, 458B are set to a value of 10, indicating that the counters 215 should be decremented. As also shown, to implement the decreasing part 349A, the polarity bit 454 is not asserted (e.g., logic (0), indicating that the nodes 120 are to transition between coupling a positive output voltage to the load(s) 111 and a bypass state responsive to the counter 215 being decremented. As also shown, to implement the decreasing part 349A of the positive part 342 of the output voltage 340, the inversion bit 456 is not asserted (e.g., logic (0)), indicating that each respective node should be transitioned from coupling energy to the load(s) 111 to the bypass state based on an order defined by the unique index value associated with the nodes, not the inverse of that order.

As also shown in FIG. 5A, to implement the negative part 344 of the output voltage 340 the polarity bit 454 is asserted (e.g., logic (1), indicating that the nodes 120 are to transition between coupling a negative output voltage to the load(s) 111 and a bypass state responsive to the counter 215. The inversion bit 456 is asserted (has a value of logic one (1)), indicating that each respective node should be transitioned from the bypass state to coupling energy to the load(s) 111 based on the inverse of the order defined by the unique index value of each node. As shown in FIG. 5A, unlike in the positive part 342, in the negative part 344 the respective node(s) N1-N8 are configured to change state in inverse order, such that a first node N1 in the order is configured to change state responsive to the counter value C=8, the second node N2 in the order is configured to change state responsive to the counter value C=7, the third node N3 in the order is configured to change state responsive to the counter value C=6, and so on including a last (eighth) node in the order N8 being configured to change state responsive to the counter value C=1.

As also shown in FIG. 5A, to implement the increasing part 348B of the negative part 344, the counter change bits 458A, 458B are set to a value of 01, indicating that the counters 215 should be incremented. As also shown in FIG. 5A, with the inversion bit 456 asserted, to implement the increasing part 348B, the counter 215 is incremented, which causes the node(s) N1-N8 to change state from a bypass mode to supplying a negative voltage to the load(s) according to an inverse of the order defined by the unique identifiers. For example, as shown the increasing part 348B in FIG. 5A, the counter is incremented from a counter value of C=1, which corresponds the node(s) N8 changing state to couple a negative voltage to the load(s) 111, to a counter value of C=8, which corresponds to the node(s) N1 changing state to couple a negative voltage to the load(s) 111, such that a minimum voltage (i.e., a maximum negative voltage) is supplied to the load(s) 111 when each of the N1-N8 nodes is operated to couple a negative voltage to the load(s) 111.

As also shown in FIG. 5A, to implement the decreasing part 349B of the negative part 344 of the output voltage 340, the counter change bits 458A, 458B are set to a value of 10, indicating that the counters 215 are to be decremented. As also shown in FIG. 5A, with the inversion bit 456 asserted, to implement the decreasing part 349B, the counter 215 is configured be decremented from a counter value of C=8, which corresponds the node(s) N1 changing to a bypass state, to a counter value of C=1, which corresponds to the node(s) N8 changing to a bypass state with the nodes N2-N7.

FIG. 5B is a plot showing one example of a counter update signal 416 being used to control nodes of a multi-level converter system 100 to generate a sinusoidal output voltage 540B. The example of FIG. 5B is substantially similar to the example of FIG. 5A and shows plurality of nodes 120 of system 100 which have been assigned a unique index value N1-N8 that indicates an order of the nodes relative to a 215 associated with each node. FIG. 5A shows the value of respective counter change bits 458A, 458B, polarity bit 454, and inversion bit 456 used to generate the respective parts of the sinusoidal output voltage 540B.

The example of FIG. 5B differs from the example of FIG. 5A in that the inversion bit 456 is not asserted in any part of the sinusoidal output voltage 540B. Instead, the order defined by the unique index value 212 sent by each node is used to sequentially change state of the respective nodes. As shown, in the increasing part 348A, the decreasing part 349A, the increasing part 348B, and the decreasing part 349B, the N1 node changes state responsive to the counter value C=1, the N2 node changes state responsive to the counter value C=2, the N3 node changes state responsive to the counter value C=3, and so on including that the N8 node changes state responsive to the counter value C=8. In some examples, where inverting order of the node(s) N1-N8 is not needed for a particular application, the counter update signal 416 may be sent without an inversion bit 456. According to such examples, the counter update signal 416 may be implemented with even fewer bits.

FIG. 5C is a plot showing one example of a counter update signal 416 being used to control nodes of an MLC system 100 to generate a sinusoidal output voltage 540C according to some embodiments. The example of FIG. 5B is substantially similar to the example of FIGS. 5A and 5B and shows plurality of nodes 120 of system 100 which have been assigned a unique index value N1-N8 that indicates an order of the nodes relative to a 215 associated with each node. FIG. 5C shows the value of respective counter change bits 458A, 458B, polarity bit 454, and inversion bit 456 used to generate the respective parts of the sinusoidal output voltage 540C.

The example of FIG. 5C differs from the example of FIGS. 5A and 5B in that the inversion bit 456 is asserted differently in the increasing parts 348A, 348B of the sinusoidal output voltage 540C than in the decreasing parts 349A, 349B of the sinusoidal output voltage 540C. As shown, the inversion bit 456 is asserted (e.g., logic 1) during the decreasing parts 349A, 349B, such that the state of the respective nodes is changed in reverse order relative to the value of the counter C, such that the last node(s) N8 is operable to change state responsive to the value C=1 of the counter, the second to last node(s) N7 is operatable to change state relative to the value C2 of the counter, and so on including the first node N1 being operable to change state relative to the value C=8 of the counter 215. According to the example of FIG. 5C, the inversion bit 456 is not asserted to generate the increasing parts 348A, 348B of the sinusoidal output voltage 540C. As shown in FIG. 5C, in the increasing parts 348A, 348B, the N1 node changes state responsive to the counter value C=1, the N2 node changes state responsive to the counter value C=2, the N3 node changes state responsive to the counter value C=3, and so on including that the N8 node changes state responsive to the counter value C=8.

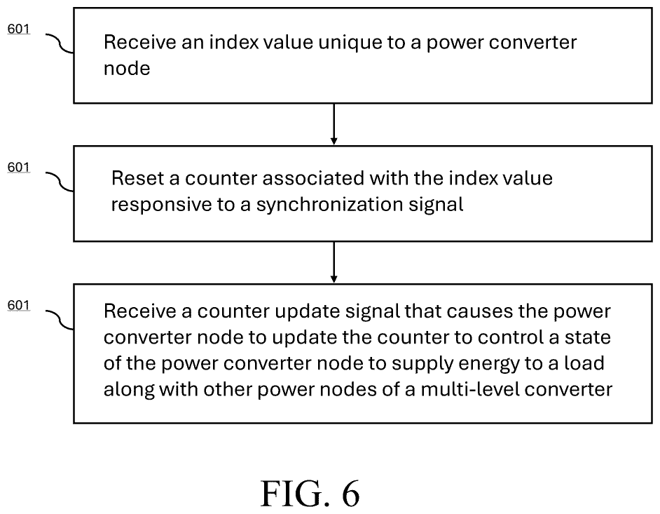

FIG. 6 is a flow diagram that depicts one example of a method of operating a node of a multi-level converter system according to some embodiments. As shown in FIG. 6, at 601, the method includes receiving an index value 112A-112H unique to a power converter node. In some examples, the index value 112A-112H may be received from a main controller 110 and specifies an order of the power converter node relative other power converter nodes. The index value 112A-112H may be unique to a single node or unique to multiple nodes grouped to change state together.

As also shown in FIG. 6, at 602, the method further includes resetting a counter 215 associated with the index value responsive to a synchronization signal 114. For example, the synchronization signal 114 may be sent by the main controller 110 and indicate that the counter 215 should be reset to a value of zero. In some examples, resetting the counter 215 corresponds to a zero crossing 341 where substantially 0 volts are supplied to the load(s) 111. In some examples, the zero crossing 341 corresponds to a switching operation of the main controller 110, in other examples the zero crossing corresponds to a load jump, the output voltage being pulled to zero, or receipt of a synchronization signal 114 to reset the counter 215. In some examples, the synchronization signal 114 is received to initiate a switching operation of system 100.

As also shown in FIG. 6, at 603, the method further includes receiving a counter update signal 116 that causes the node controller 222 to update the counter 215 to control a state of the power converter node to supply energy to the load(s) 111 along with other power nodes of a MLC system 100. In some examples, the method further includes performing one or more of: incrementing the counter, decrementing the counter, and resetting the counter to zero responsive to the counter update signal 116.

In some examples, the method further includes changing a state of the power converter node to supply energy to the load(s) 111 responsive to the counter update signal 116 when a value of the counter 215 corresponds to the index value 112A-112H. For example, the method may include changing the state of the node when the value of the counter equals the index value. As another example, the method may include changing the state of the node when the value of the counter is greater than or less than the index value 112A-112H, for example where a prior counter update signal 116 was missed due to a transmission error. In some examples, the method further includes leaving a state of the power converter node 122A-122H unchanged responsive to the counter update signal 116 when a value of the counter does not correspond to the index value 112A-112H. In some examples, the value of the counter does not correspond to the index value 112A-112H when the counter value is less than the index value.

In some examples, the method further includes repeatedly receiving the counter update signal 116 as a broadcast from a main controller 110 to define a switching operation of the power node and other power nodes of the multi-level converter system 100 to collectively generate a sinusoidal output voltage 340. In some examples, the method further includes receiving the synchronization signal 114 of the multi-level converter system 100 when a sinusoidal output voltage 340 supplied to the load(s) 111 is zero or close to zero. In some examples, the method further includes receiving the index value 112A-112H when the converter nodes 122A-122H are operated to couple energy to the load(s) 111. In some examples, the method further includes receiving the index value 112A-112H when the converter nodes 122A-122H are operated in bypass such that no current is supplied to the load(s) 111.

### Clauses

Clause 1. A power converter node, configured to: receive an index value unique to the power converter node; reset a counter associated with the index value responsive to a synchronization signal; receive a counter update signal that causes the power converter node to update the counter to control a state of the power converter node to supply energy to a load along with other power nodes of a multi-level converter.

Clause 2. The power converter node of clause 1, wherein the counter update signal is received from a main controller and indicates whether the power converter node is to one or more of: increment the counter; decrement the counter; and reset the counter to zero.

Clause 3. The power converter node of any of clauses 1 and 2, wherein the power converter node is further configured to: change a state of the power converter node to supply energy to the load responsive to the counter update signal when a value of the counter corresponds to the index value.

Clause 4. The power converter node of clause 3, wherein the value of the counter corresponds to the index value when the counter value is equal to the index value.

Clause 5. The power converter node of any of clauses 3 and 4, wherein the value of the counter corresponds to the index value when the counter value is incremented, the index value is greater than the counter value, and a previous counter update signal was missed by the power converter node.

Clause 6. The power converter node of any of clauses 3-5, wherein the value of the counter corresponds to the index value when the counter value is decremented, the index value is less than the counter value, and a previous counter update signal was missed by the power converter node.

Clause 7. The power converter node of any of clauses 1-6, wherein the power converter node is further configured to: leave a state of the power converter node unchanged responsive to the counter update signal when a value of the counter does not correspond to the index value.

Clause 8. The power converter node of any of clauses 1-7, wherein the power converter node is further configured to: repeatedly receive the counter update signal as a broadcast from a main controller to define a switching operation of the power node and other power nodes of the multi-level converter to generate a sinusoidal output voltage.

Clause 9. The power converter node of any of clauses 1-8, wherein the power converter node is further configured to: receive the synchronization signal of the multi-level converter when a sinusoidal output voltage supplied to the load is zero or close to zero.

Clause 10. The power converter node of any of clauses 1-9, wherein the counter update signal includes a pair of counter change bits that indicate whether the counter should be incremented, decremented, or reset.

Clause 11. The power converter node of clause 10, wherein the counter update signal further includes at least one polarity bit which indicates whether the converter node is to supply an output voltage of a first polarity or a second polarity to the load responsive to the counter update signal.

Clause 12. The power converter node of any of clauses 10 and 11, wherein the counter update signal further includes an inversion bit that indicates whether an order of the unique index value of the converter node relative to other converter nodes of the multi-level converter is to be inverted.

Clause 13. A main controller configured to: send a unique index value to multiple power converter nodes; send a synchronization signal that causes the multiple power converter nodes to reset a counter associated with the index value; send a counter update signal to the multiple power converter nodes that causes the multiple power converter nodes to update the counter to control a state of the multiple power converter nodes to supply energy to a load.

Clause 14. The main controller of clause 13, wherein the unique index value is unique to a grouping of power converter nodes.

Clause 15. The main controller of any of clauses 13 and 14, wherein the main controller sends the counter update signal to one or more of: increment the counter; decrement the counter; and reset the counter to zero.

Clause 16. The main controller any of clauses 13-15, wherein the main controller is further configured to: repeatedly send the counter update signal as a broadcast to define a switching operation of the multiple power converter nodes to generate a sinusoidal output voltage.

Clause 17. A method, comprising: receiving an index value unique to a power converter node; resetting a counter associated with the index value responsive to a synchronization signal; receiving a counter update signal that causes the power converter node to update the counter to control a state of the power converter node to supply energy to a load along with other power nodes of a multi-level converter.

Clause 18. The method of clause 17, wherein the counter update signal indicates whether the power converter node is to one or more of: increment the counter; decrement the counter; and reset the counter to zero.

Clause 19. The method of any of clauses 17 and 18, further comprising: changing a state of the power converter node to supply energy to the load responsive to the counter update signal when a value of the counter corresponds to the index value.

Clause 20. The method of any of clauses 17-19, further comprising: repeatedly receiving the counter update signal as a broadcast from a main controller to define a switching operation of the multi-level converter to generate a sinusoidal output voltage.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A power converter node, configured to:
receive an index value unique to the power converter node;
reset a counter associated with the index value responsive to a synchronization signal;
receive a counter update signal that causes the power converter node to update the counter to control a state of the power converter node to supply energy to a load along with other power nodes of a multi-level converter.

2. The power converter node of claim 1, wherein the counter update signal is received from a main controller and indicates whether the power converter node is to one or more of:
increment the counter;
decrement the counter; and
reset the counter to zero.

3. The power converter node of claim 1, wherein the power converter node is further configured to:
change a state of the power converter node to supply energy to the load responsive to the counter update signal when a value of the counter corresponds to the index value.

4. The power converter node of claim 3, wherein the value of the counter corresponds to the index value when the counter value is equal to the index value.

5. The power converter node of claim 3, wherein the value of the counter corresponds to the index value when the counter value is incremented, the index value is greater than the counter value, and a previous counter update signal was missed by the power converter node.

6. The power converter node of claim 3, wherein the value of the counter corresponds to the index value when the counter value is decremented, the index value is less than the counter value, and a previous counter update signal was missed by the power converter node.

7. The power converter node of claim 1, wherein the power converter node is further configured to:
leave a state of the power converter node unchanged responsive to the counter update signal when a value of the counter does not correspond to the index value.

8. The power converter node of claim 1, wherein the power converter node is further configured to:
repeatedly receive the counter update signal as a broadcast from a main controller to define a switching operation of the power node and other power nodes of the multi-level converter to generate a sinusoidal output voltage.

9. The power converter node of claim 1, wherein the power converter node is further configured to:
receive the synchronization signal of the multi-level converter when a sinusoidal output voltage supplied to the load is zero or close to zero.

10. The power converter node of claim 1, wherein the counter update signal includes a pair of counter change bits that indicate whether the counter should be incremented, decremented, or reset.

11. The power converter node of claim 10, wherein the counter update signal further includes at least one polarity bit which indicates whether the converter node is to supply an output voltage of a first polarity or a second polarity to the load responsive to the counter update signal.

12. The power converter node of claim 10, wherein the counter update signal further includes an inversion bit that indicates whether an order of the unique index value of the converter node relative to other converter nodes of the multi-level converter is to be inverted.

13. A main controller configured to:
send a unique index value to multiple power converter nodes;
send a synchronization signal that causes the multiple power converter nodes to reset a counter associated with the index value;
send a counter update signal to the multiple power converter nodes that causes the multiple power converter nodes to update the counter to control a state of the multiple power converter nodes to supply energy to a load.

14. The main controller of claim 13, wherein the unique index value is unique to a grouping of power converter nodes.

15. The main controller of claim 13, wherein the main controller sends the counter update signal to one or more of:
increment the counter;
decrement the counter; and
reset the counter to zero.

16. The main controller of claim 13, wherein the main controller is further configured to:
repeatedly send the counter update signal as a broadcast to define a switching operation of the multiple power converter nodes to generate a sinusoidal output voltage.

17. A method, comprising:
receiving an index value unique to a power converter node;
resetting a counter associated with the index value responsive to a synchronization signal;
receiving a counter update signal that causes the power converter node to update the counter to control a state of the power converter node to supply energy to a load along with other power nodes of a multi-level converter.

18. The method of claim 17, wherein the counter update signal indicates whether the power converter node is to one or more of:
increment the counter;
decrement the counter; and
reset the counter to zero.

19. The method of claim 17, further comprising:
changing a state of the power converter node to supply energy to the load responsive to the counter update signal when a value of the counter corresponds to the index value.

20. The method of claim 17, further comprising:
repeatedly receiving the counter update signal as a broadcast from a main controller to define a switching operation of the multi-level converter to generate a sinusoidal output voltage.
